(19) United States
(12) Patent Application Publication
(10) Pub. No.: US 2002/0101449 A1
(43) Pub. Date: Aug. 1, 2002

(54) System and method for developing and processing a graphical user interface for a computer application

(75) Inventor: James Friskel, Cocoa Beach, FL (US)

Correspondence Address: MORGAN LEWIS & BOCKIUS LLP, 1111 PENNSYLVANIA AVENUE NW, WASHINGTON, DC, 20004, US

(73) Assignee: NeoPlanet, Inc.

(21) Appl. No.: 10/058,097

(22) Filed: Jan. 29, 2002

Related U.S. Application Data
(60) Provisional application No. 60/264,884, filed on Jan. 29, 2001.

(51) Int. Cl. G09G 5/00

(52) U.S. Cl. 345/762

(57) ABSTRACT

A system for developing and processing a complex graphical user interface for a computer application program includes a computer system for executing a application program process. The process is driven by a graphics engine that manages a plurality of corresponding graphics file and configuration file pairs that together define the entire user interface for the application, and each of the plurality of graphics file and configuration file pairs corresponds to a window that forms at least a portion of the user interface. Each graphics file contains at least one image defining a window that is part of the user interface, and the configuration file contains parameters that define how the graphics engine processes the graphics file. These parameters also define actions and point to software or content that may be initiated or embedded by the user through the user interface.

### BACKGROUND OF THE INVENTION

This application claims the benefit of a provisional application entitled “System and Method for Developing and Processing a Graphical User Interface for a Computer Application,” that was filed Jan. 29, 2001 and assigned Provisional Application No. 60/264,884, which is hereby incorporated by reference.

The present invention relates in general to the development of graphical computer applications, and more particularly to a system and method for developing and processing computer files corresponding to a graphical image and its associated functionality for display as part of the user interface for a computer application or for other rendering purposes in a computer system.

A large number of complex graphical images often must be created for various screens presented as part of the user interface for a computer program, such as, for example, an Internet browser. These graphical images define the visual portion of the user interface and may require considerable development time to create. For example, the development cycle for a computer program having a complicated, production-quality user interface may extend over several months. Prior approaches to the development of applications having such complex images have required that the developer write a dedicated computer program or use many graphics files embedded in a computer program such as a web browser. Also, after such a complex interface is developed, it can be very time consuming to make changes to the interface, such as, for example, the addition of new windows, buttons, or other graphical features. It would be desirable to significantly reduce the development time and effort required to design such a complex graphical user interface.

Accordingly, there is a need for an improved way to create and modify a computer application that uses complex graphical images for display as part of the user interface for the application.

### SUMMARY OF THE INVENTION

Accordingly, the present invention is directed to a system and method for developing and processing a graphical user interface for a computer application that substantially obviates one or more of the problems due to limitations and disadvantages of the related art.

The graphical processing system and method of the present invention have the advantages of providing a rapid prototyping development system for designing user interfaces having complex graphics, in particular those with significantly irregular shapes. In addition, the combination of multiple images corresponding to varying states in a single graphics file permits greatly faster development for complicated graphical interfaces. Further, the graphical processing procedure described above permits easier definition of the functionality of a user interface compared to prior development approaches.

One embodiment of the present invention allows third parties to more easily design and define applications having complex graphical user interfaces. Thus, an artist or marketer or a non-technically trained person, rather than a computer programmer, can quickly, efficiently, and easily customize the user interface. Moreover, one embodiment of the present invention allows a business to quickly customize the user interface of an application for its clients without having to redesign large portions of the interface. Further, modifications of existing user interface designs can be more quickly made based on new client requests for changes.

Other advantages are that the application programs created according to one embodiment of the present invention can readily add new functions by editing the configuration files. Also, links to other content or applications that are provided in the configuration file can be dynamically updated, such as using a server computer. Further, application program features can be dynamically added and removed through such dynamic updating.

As an additional advantage, the graphics engine according to one embodiment of the present invention manages multiple graphics and configuration file pairs to present several different windows as part of the user interface. Each of these windows is defined by a corresponding graphics file/configuration file pair. Moreover, each window presents the entire user interface in that the window is not placed within or bounded by the viewing area of another application, such as used with prior framing approaches. Further, in general any portion of the entire user interface can be defined as an activation region with a corresponding function. For example, the “Close” icon for closing a window in an application can be defined as an activation region and positioned on any portion of the default image in the graphics file. This is in contrast to prior web browser or other applications in which the “Close” icon must remain in the top right-hand corner of the application window and cannot be readily re-positioned by simple edits to a configuration file/graphics file pair.

Additional objects and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a computer system for performing graphical image processing according to one embodiment of the present invention;

FIG. 1A illustrates a computer system for performing graphical image processing using a client computer and a server computer;

FIG. 2 illustrates a screen image, used for providing a portion of a user interface for a computer program, that is displayed according to one embodiment of the present invention;

FIGS. 3A-3D illustrate an exemplary image configuration file used for processing a graphical image according to one embodiment of the present invention;

FIG. 4 illustrates exemplary contents of a graphics file according to one embodiment of the present invention; and

FIG. 5 illustrates the management of multiple windows by a graphics engine according to one embodiment of the present invention.

### DETAILED DESCRIPTION OF THE EMBODIMENTS

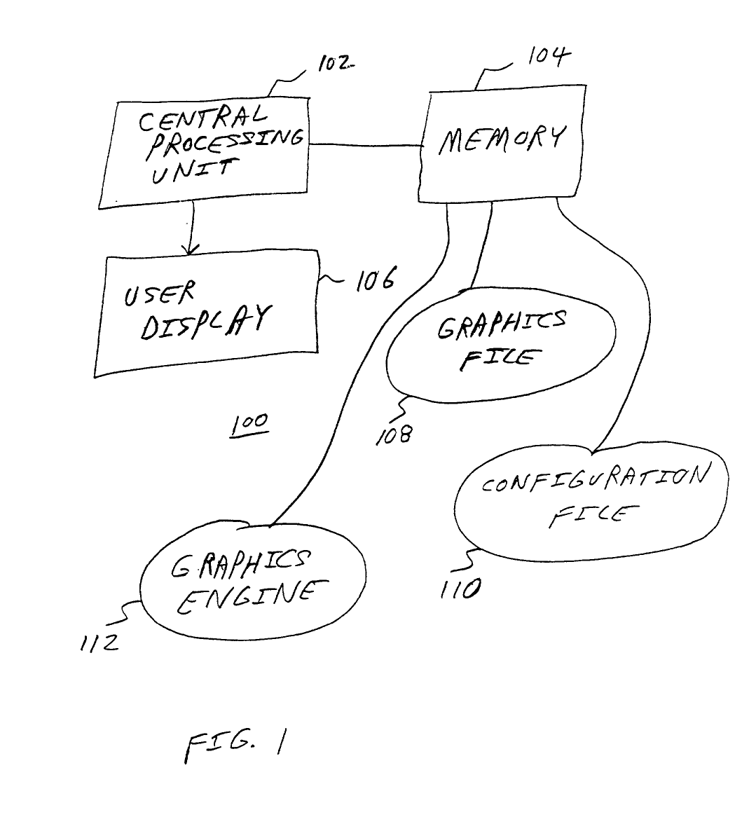

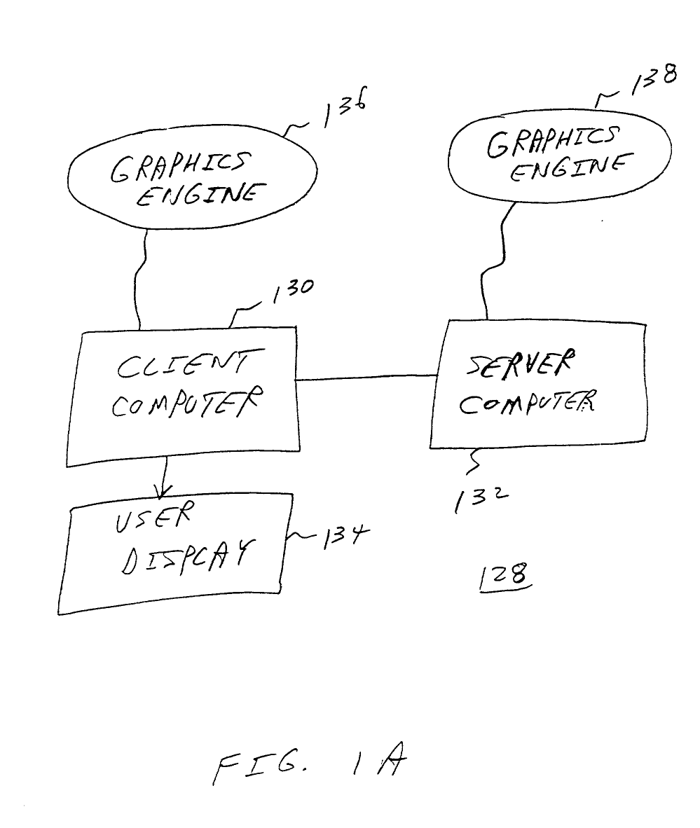

FIG. 1 illustrates a computer system 100 comprising a central processing unit 102 coupled to a memory 104 and a user display 106. Computer system 100 is any general purpose computer system such as, for example, a personal computer using an INTEL microprocessor running under the MICROSOFT WINDOWS operating system. Memory 104 is, for example, a hard drive or optical drive used to store computer programs for execution by central processing unit 102. User display 106 is for example a video or LCD monitor used to display images to a user of computer system 100. Other computer systems, memories, and user displays will be known to those skilled in the art and are within the scope of the present invention.

According to one embodiment of the present invention, a graphics engine computer program 112 (or simply “graphics engine”), which is stored in memory 104, is executed on central processing unit 102. During execution, graphics engine 112 reads a configuration file 110, which is used to process an image contained in a graphics file 108 for display to the user on user display 106. Graphics engine 112 may be implemented in any of several conventional programming languages. As will be discussed further below, the execution of graphics engine 112 supports the user interface for a computer application. Graphics file 108 defines the graphical features of the entire visibly-displayed image for the user interface, and configuration file 110 contains parameters that are used by graphics engine 112 to associate functionality with the contents of graphics file 108. The parameters in configuration file 110 are presented in a scripting language that can be read and processed by graphics engine 112. Graphics engine 112 is running as a process in computer system 100, and this process reads configuration file 110 and graphics file 108 in order to display a user interface. This user interface and the process running graphics engine 112 together provide an application program that permits the user of computer system 100 to initiate the functionality designed into the application program.

As will be discussed in more detail below, an advantage according to the present invention is that the initial development of the application program (also referred to herein as “application”) and subsequent modifications to the application can be accomplished merely by creating and modifying graphics file 108 and configuration file 110. No re-compilation of graphics engine 112 is required as part of creating or modifying the application. Thus, the application can be created and/or updated by persons having less skill than would be required to create and modify the computer programming code used to provide graphics engine 112. The application defined by graphics file 108 and configuration file 110 provides, in general, the same functionality that any other application running on computer system 100 could provide. For example, the application provides for the calling of external applications available on computer system 100, which permits the launching of a separate media player or other applications known to those skilled in the art. In contrast to the present invention, prior approaches for the development of applications with complex graphical user interfaces have required that the creator embed graphical images into the shell of another application, such as, for example, the calling of a large number of hyper-text markup language (HTML) web pages by a web browser.

FIG. 1A illustrates a computer system 128 for performing graphical image processing using a client computer 130 and a server computer 132. A user display 134 is coupled to client computer 130. A graphics engine computer program 136 is stored and executed on client computer 130, and a graphics engine computer program 138 is stored and executed on server computer 132. Graphics engine 138 may perform similar processing as is done by graphics engine 136 for any configuration file and graphics file pairs stored on server computer 132.

Also, server computer 132 may optionally send updates to client computer 130 for updating the contents of graphics file 108 and/or configuration file 110. These updates can be made dynamically and automatically without the need for the user of client computer 130 to initiate or request these updates. Instead, the sending of these updates can be initiated by other software that is running on client computer 130 and/or server computer 132. For example, an initiating event might be the determination by such other software running on client computer 130 that the user of client computer 130 is of a certain age, as determined by data previously provided by such user for such determination and stored on client computer 130, and has installed a particular type of hardware on client computer 130. The updates provided by server computer 132 in response may be targeted in a marketing, advertising, or other way to certain of the characteristics of client computer 130 or its user. For example, the application program created using the present invention may be modified by such updates to include a new window directed to product or service offerings, which are related to the initiating event, and related purchase transactions that the user of the application program can initiate. This new window and its available functions would become a part of the application program being controlled by graphics engine 136.

Alternatively, the above updates may be initiated by server computer 132. For example, an advertiser or sponsor of an application program on client computer 130 may desire to change the application based on changes in marketing or other business strategies such as the offering of a new product or service. It should be appreciated that as part of the client or server updates described above, any links to other content or applications that are provided in configuration file 110 may be changed. Such link changes can correspond to changes made as part of the marketing or other business changes associated with the advertiser or sponsor.

The initiating event described above may be, in general, any action or situation or characteristic associated with the user of client computer 130 or of client computer 130 itself. Separate rules evaluation software (hereinafter referred to as a “rules engine”) may be installed and running on client computer 130 to monitor information provided from data stored on client computer 130 or hardware or software information available through the operating system or other means known to those skilled in the art. The rules engine (not shown) evaluates several rules corresponding to certain user or client computer information to determine whether the initiating event has occurred. For example, a first rule may query whether the user's age is greater than 18. A second rule may query whether the user has installed a digital camera on client computer 130. The rules engine evaluates the truth or falsity of each rule and takes appropriate action in response.

For example, the rules engine may be programmed to initiate an update when the first rule and second rule above are each true. Alternatively, the rules engine may be programmed to initiate an update when either the first rule or the second rule is true. In a similar manner, the rules engine may be programmed with several combinations of rules wherein each combination of rules corresponds to a different initiating event.

By programming the rules engine, complicated sets of initiating events and updates can be implemented. Further, a separate rules engine may be installed and run on server computer 132 that communicates with the rules engine on client computer 130. Moreover, a rule may call another rule so that rules may be chained. Further, a rule may initiate the downloading of yet additional rule combinations from server computer 132.

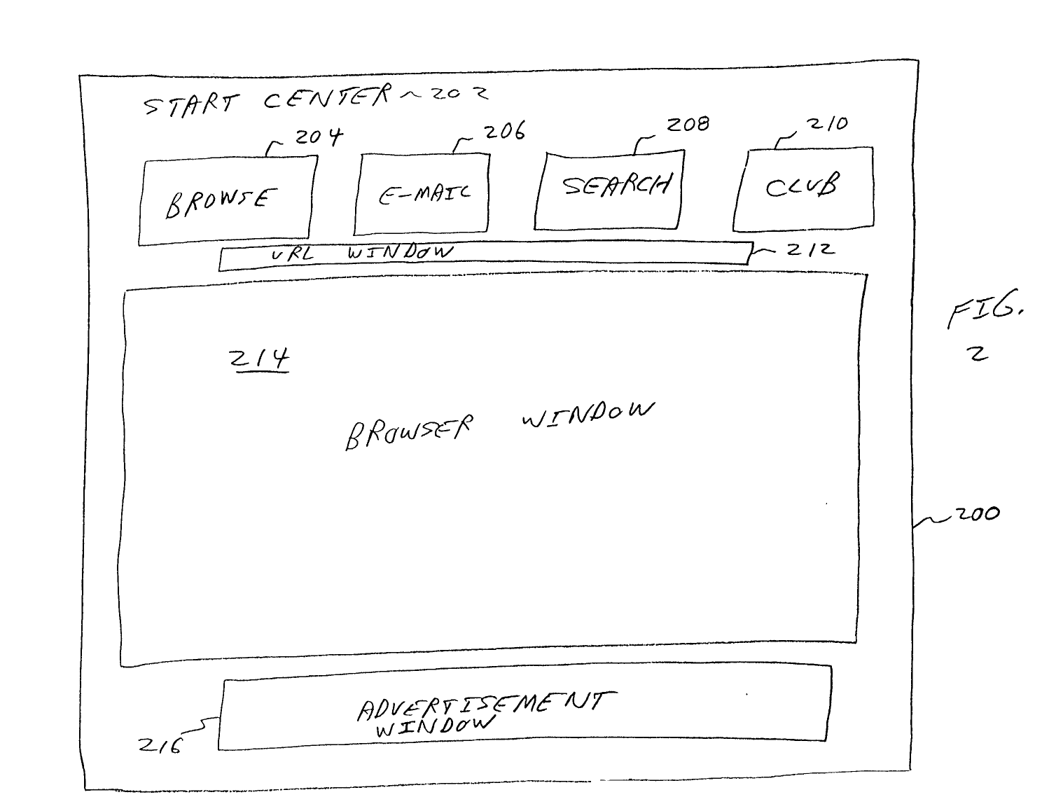

FIG. 2 illustrates a screen image 200 that is displayed on user display 106 to provide a portion of a user interface for a computer application or program, for example an Internet browser, running on computer system 100. Image 200 corresponds, for example, to a screen shot or window for the user interface of the Internet browser. As discussed further below, a computer application developed using the present invention will generally contain many windows or screen shots that are presented to the user on user display 106. For purposes of illustration, the discussion below initially describes a single one of such screen shots identified as image 200.

Image 200 comprises graphical content, such as text 202, and may contain other graphical content, such as advertisements, buttons, or user information. Image 200 may also contain internal windows used to provide dynamic content to the user. Specifically, boxes 204, 206, 208, and 210 present activity options to the user that may be activated using, for example, a mouse or other pointing device. For example, a user's clicking on box 206 will activate an electronic mail window (not shown), which permits the user to manage electronic mail. As discussed below, the electronic mail window itself will be defined by its own graphics and configuration file pair, which is also processed by graphics engine 112.

A URL window 212 permits the user to enter new URL addresses to download new content to image 200. A browser window 214 displays content downloaded by the user, and an advertisement window 216 contains dynamic advertisement content displayed to the user.

As will be discussed in more detail below, image 200 is displayed by the processing of configuration file 110 and graphics file 108 using graphics engine 112. Graphics file 108, in particular, contains a graphical image that corresponds to image 200. This graphical image may be created using a conventional bit-map graphics editor such as, for example, MICROSOFT PAINT. Alternatively, the graphic image may be created using graphic editors that support other graphic formats (e.g., JPG). Configuration file 110 contains a plurality of parameters that correspond to the graphical image in graphics file 108 and that in part define the actions that may be initiated by the user by pointing and activating selected activation regions of image 200.

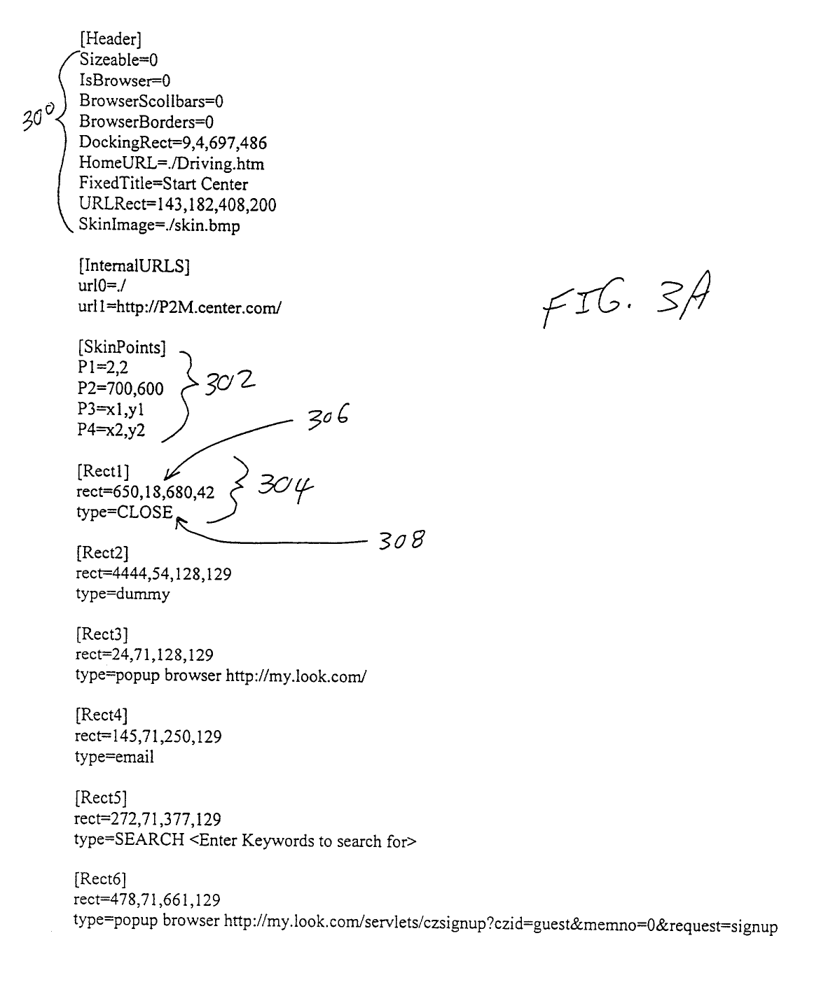

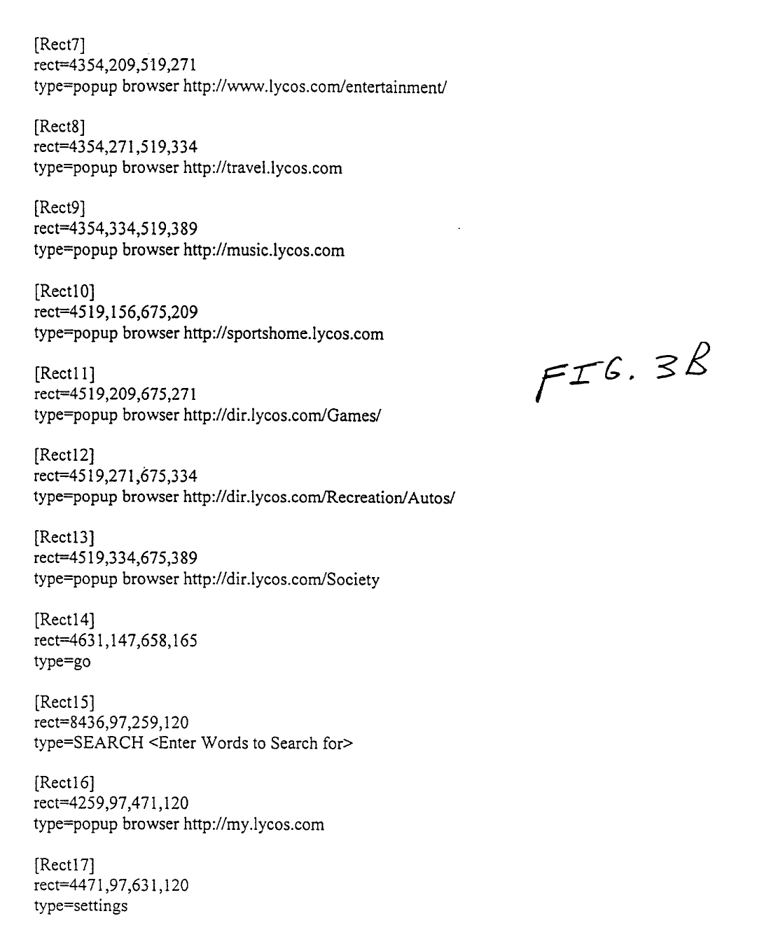

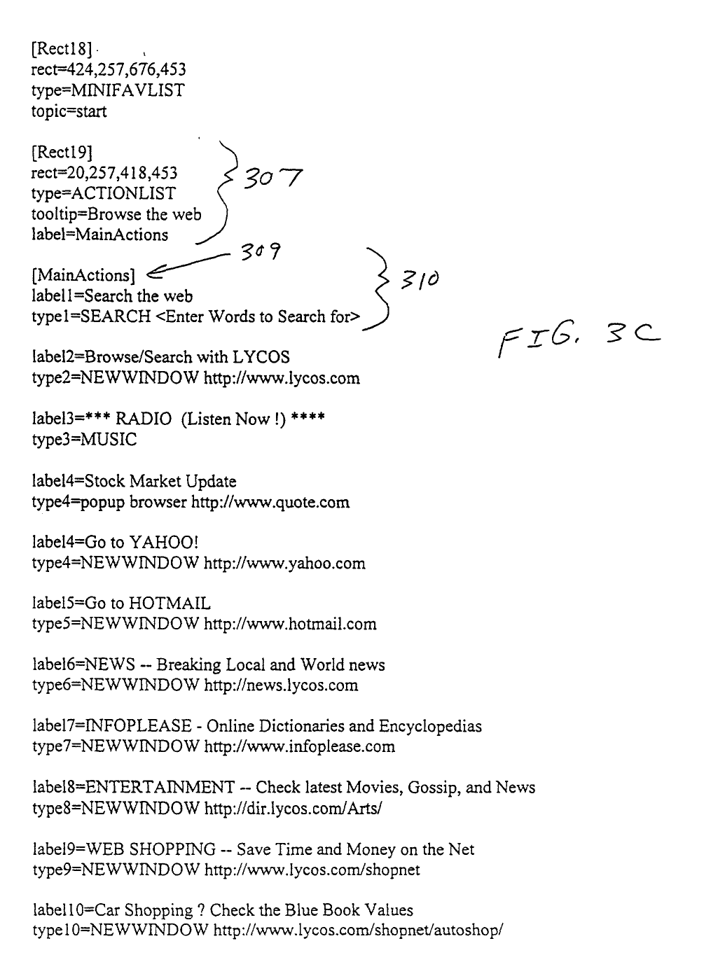

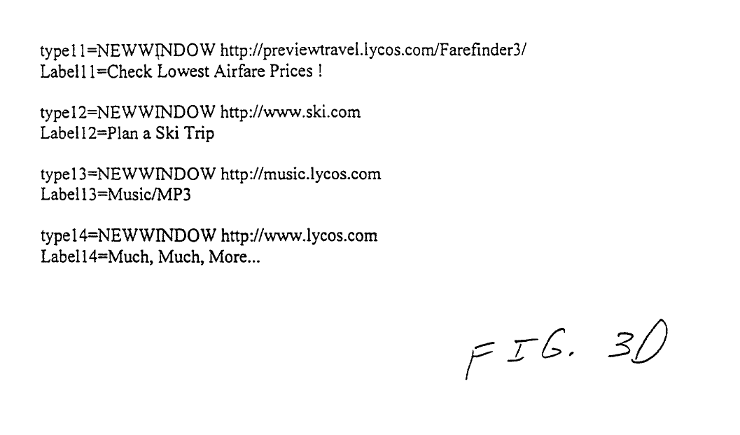

FIGS. 3A-3D illustrate exemplary contents for configuration file 110. In general, configuration file 110 may be any computer file that can be read by graphics engine 112 and that contains parameters to guide the processing and display of a graphical image defined by graphics file 108. For example, configuration file 110 may be a text file. In other embodiments, a standard extensible mark-up language (XML) or other appropriate format may be used. Configuration file 110 contains parameters that define further actions that may be requested by the user of computer system 100 through the user interface for an application developed according to one embodiment of the present invention.

Configuration file 110 comprises header information 300, skin points 302, and activation region definitions 304. Header information 300 includes information that is passed to the operating system running on computer system 100 to describe operating system aspects of the windows associated with image 200. Header 300 also includes a parameter SkinImage=./skin.bmp, which identifies graphics file 108, for example by providing a directory path.

In the present embodiment, Graphics file 108 (which is further illustrated later below) is, for example, a bitmapped file containing one or more bit-mapped images corresponding to image 200. In the simplest case, graphics file 108 contains a single image that corresponds directly to image 200. In other cases, discussed further below, graphics file 108 contains more than one image corresponding to different states of image 200, which states are dependent on the actions taken by the user when interacting with image 200.

Skin points 302 include bit-mapped coordinates for two points P1 and P2 (defined using x and y bit-map coordinates) to provide an overall bounding rectangle within which the graphical image stored in graphics file 108 is contained. This is done because the graphical image typically will have an irregular shape that deviates significantly from a conventional rectangular shape. The bounding rectangle identifies the location within graphics file 108 of the graphical image to graphics engine 112. Other skin points may provide other information about the graphical image, for example, such as points P3 and P4 to give the location of URL windows within the final displayed image or even other points to define tiling and stretching regions for sizable, irregularly-shaped graphical images. The position given by points P3 and P4 in FIG. 3A is indicated generally by x1, y1 and x2, y2.

A plurality of activation region definitions 304 are provided in configuration file 110 and comprise a label to identify the activation region, for example [Rect1], a location definition 306 such as rect=650,18,680,42 that provides (x, y) coordinates for the two opposite ends of a bounding rectangle to identify the portion of image 200 that is an activation region, and an activation region type 308 such as, type=CLOSE, to identify the action associated with the activation region. Several examples of activation region definitions 304 are illustrated in FIGS. 3A, 3B, and 3C, as indicated by the labels [Rect1] through [Rect19]. Each of activation region definitions 304 correspond to an activation region associated with image 200. Activation regions are portions of image 200 that are associated with an action or function supported by computer system 100 through its operating system or otherwise. These actions and functions will typically include any operating system function available to processes running on computer system 100, any other functions that can be implemented by a conventional Internet web browser, the embedding of any embeddable objects or software permitted by the operating system (for example, a calculator or a media player), or any function that may be provided by an externally linked d11 file. Such actions also may include the ability to embed a web browser within image 200 (for example, in window 214).

As an example of one such activation region, box 206 (shown in FIG. 2) may be defined as an e-mail type activation region in configuration file 110 with an indication of type=email. When a user clicks on box 206 in image 200, graphics engine 112 associates this user action with an e-mail activation definition and opens an e-mail window in which the user can manage e-mail using, for example, an e-mail manager. A separate computer program may act as the e-mail manager.

It should also be noted that activation region definitions 304 can define additional attributes that are associated with certain types of activation regions. For example, one type may be an browser status bar, which is a colored bar that moves gradually across the screen to indicate the extent to which a web page has been loaded. The color of the bar is an attribute that is specified in configuration file 110 when this type is associated with an activation region.

Activation region types can include almost any action or event that computer system 100 is capable of supporting including, for example, the closing of a window, the opening of a new browser window with content pointed to by the corresponding activation region definition 304, the opening of another program such as a media player, ActiveX® controls, and the presentation of a menu window permitting the user to launch other actions. For example, activation region definition 307 (shown in FIG. 3C) defines a menu window and includes an action list 309 comprising a plurality of label definitions 310 that define the contents of the menu and each corresponding action that may be initiated. Several examples of label definitions 310 are illustrated in FIGS. 3C and 3D, as indicated by the numbered wording “label1” through “label14”.

One type of activation region includes the importing of a dynamically linked library (or d11) file into a process running on computer system 100. One advantage of such importing of d11 files through an activation region is that a third party not associated with the original development of an application can provide functionality unique to the third party and not necessarily known to or anticipated by the original developer. It should be noted that the d11 file may be passed information associated with image 200 using operating system features. Also, as part of the updates by server computer 132 discussed above, links to such external d11 files can be provided in the updates to configuration file 110 so that new functionality is easily and dynamically added to the application program.

Another type of activation region according to the present invention initiates the recursive use of additional corresponding graphics and configuration file pairs. Specifically, an activation region can have a type that points to a second configuration file, which when processed by graphics engine 112 leads to the opening of a new window having its own activation regions as defined by a second graphics file. This recursive procedure can be repeated through several levels and provides substantial flexibility in creating and modifying the chaining of large number of user interface windows associated with an application program being managed by graphics engine 112.

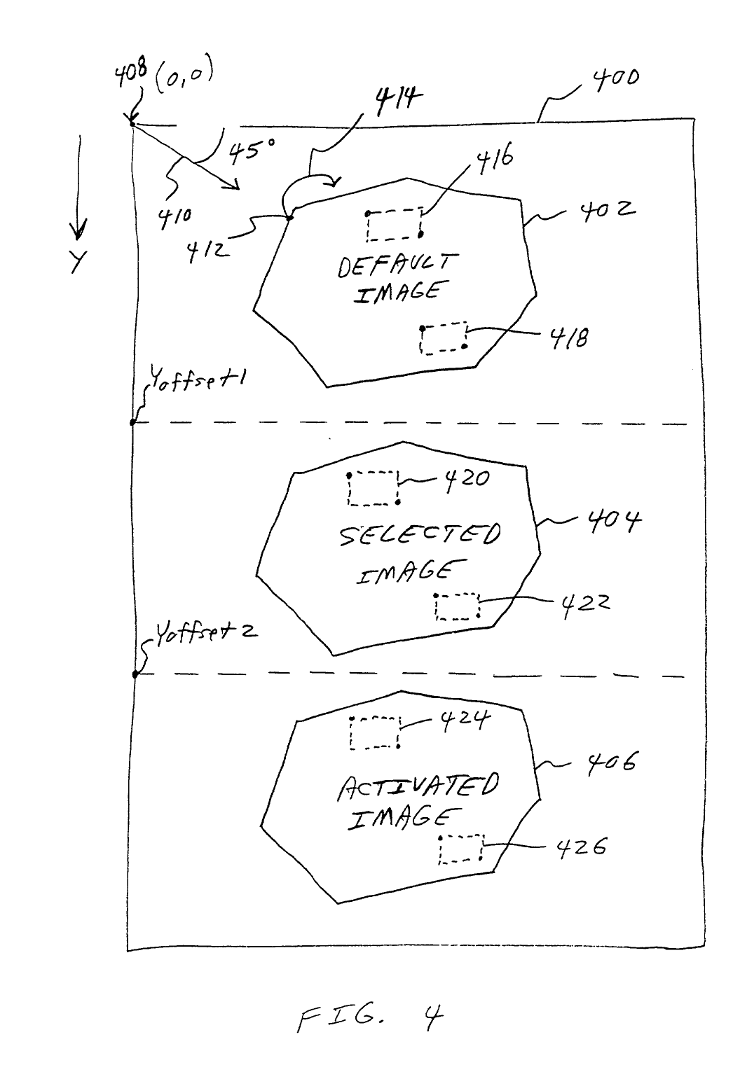

FIG. 4 illustrates an example of the contents 400 of graphics file 108 according to one embodiment of the present invention. In the discussion above, graphics file 108 was discussed in the context of its containing a single graphical image. However, as illustrated in FIG. 4 according to the present embodiment, graphics file 108 in general may contain one or more graphical images. For purposes of illustration, irregularly-shaped images (that differ in shape from image 200) are shown in contents 400. With reference to FIG. 4, contents 400 comprises graphical images 402, 404, and 406. Contents 400 may be stored in graphics file 108, for example, as a single bit-mapped image. Each of graphical images 402, 404, and 406 corresponds to the image 200 to be presented to the user, and each of the graphical images corresponds to a different state of the user interface. Specifically, image 402 corresponds to a default state of the user interface. Image 200 as displayed on user display 106 will correspond generally to the default state image 402. Image 404 corresponds to image 200 when in a selected state, for example in which the user has positioned a mouse pointer over a defined activation region. Image 406 corresponds to image 200 when in an activated state, for example in which the user has clicked on or activated the mouse pointer when it is positioned over a defined activation region.

It should be appreciated that unlike prior approaches for developing user interfaces for application programs, the above approach simplifies the preparation of the graphical aspects of the user interface in part by providing the entire image, which includes its full extent and external boundary, in graphics file 108. For example, image 402 is the entire image that will appear as part of the application program run by graphics engine 112. Accordingly, image 402, which may be irregular in shape, defines the external boundary of the visible user interface that will appear to the user. Further, the visible user window that may be defined in shape by image 402 may be resized by graphics engine 112 and/or the user. This is in contrast to prior approaches using HTML files that link to several images which appear within the window frame of, for example, a web browser. Within image 402, activation regions will be defined as discussed above to provide all of the functionality desired for the application. By providing all aspects of image 402 in a single file, it is not necessary for an application developer to keep track of the placement of a large number of images scattered throughout several different files. Further, according to one embodiment of the present invention, selected image 404 and activated image 406 are provided in the same graphics file 108. This substantially simplifies and speeds up development because the relative positions of the differences in graphical images that are incorporated within, for example, selected image 404 in activation regions 420 and 422 (which are discussed further below) are readily seen by the developer during development. The development time for creating such an application program for a third party is also substantially shortened according to the system and method of one embodiment of the present invention.

In an alternative embodiment, selected image 404 and/or activated image 406 may be stored in one or more additional graphic files. In another alternative embodiment, activation regions 420 and 422 may be stored in one or more additional graphic files.

In general, those portions of selected image 404 and activated image 406 that are not contained within defined activation regions will not be used by graphics engine 112 to create and display image 200 even when the mouse pointer is over or has clicked on an activation region. Thus, the memory requirements for storing contents 400 in a computer file are typically increased. However, the providing of the entire user interface in default image 402, selected image 404, and activated image 406 simplifies the initial development and later modification of the user interface. In contrast, prior approaches require the developer to mentally visualize or create temporary working copies of graphical images to properly embed graphical edits into the existing defined user interface images.

Image 200 will vary as the user, for example, moves a mouse pointer around various portions of image 200. Activation regions 416 and 418 are shown in image 402 and will have corresponding activation region definitions 304 in configuration file 110. Images 404 and 406 will have corresponding activation regions 420, 422, 424, and 426, having the same (x,y) coordinates as activation regions 416 and 418, but different graphics within each respective activation region for display to the user when the activation region is selected or activated.

Alternatively, the corresponding activation regions may have different coordinates than activation regions 416 and 418. In other words, the corresponding activation regions may be located at different coordinates within the corresponding image or may be located at different coordinates in one or more additional graphic files.

As a user, for example, selects activation region 416, graphics engine 112 will define and display image 200 by pulling the graphical content from region 420 of image 404 instead of the default graphical content from region 416. The remainder of the displayed image is defined by the remaining portion of image 402 not within the activation region. An example of a variation in graphical content between regions 416 and 420 is that normal text presented in region 416 may be bolded text of a different color in region 420. Accordingly, the user would see bolded text of a first different color when moving the mouse pointer over activation region 416 in image 200 on user display 106.

Similarly, as the user clicks on or activates activation region 416, graphics engine 112 pulls graphical content from region 424 of image 406 to use in defining image 200 for display in this activated state. For example, the user may see that the text in the activation region has now been highlighted in a second different color as the user clicks on a mouse button.

When graphics file 108 contains more than one image as just described, configuration file 110 will have additional offset parameters included in header 300 to enable graphics engine 112 to identify the images for the additional states provided. Examples of these offsets are illustrated as Y_{offset1}, and Y_{offset2} in FIG. 4. Further, if selected image 404 and activated image 406 (or the corresponding activation regions) are stored in one or more additional graphic files, the configuration file 110 may have parameters to identify the location of such files or portions of files.

When processing graphics file 108 for display, graphics engine 112 determines those portions of contents 400 that will be displayed as part of image 200 and those other portions that will not be visibly displayed to the user. This is done in one approach by partitioning image 400 into transparent and visible color regions. For example, when the user interface is in a default state, image 402 will be displayed as a visible image to the user. The other portion of contents 400 surrounding image 402, but contained in the overall image rectangle defined by the skin points P1 and P2 mentioned above, will not be displayed to the user.

In doing the above partitioning into transparent and visible color regions, graphics engine 112 defines a polygon in the working memory (not shown) of computer system 100. This polygon corresponds to the external boundary of image 402. The coordinates for this polygon may be determined, for example, using the MICROSOFT'S WINDOWS 2000 operating system. Alternatively, graphics engine 112 may determine the color of the corner pixel at point 408 in contents 400 as indicated by coordinate notation (0,0) in FIG. 4 and examine pixels moving along a 45° angle as shown by arrow 410 until identifying a point 412 having a differing color. Point 412 is thus stored as one point of the polygon. Further conventional processing is then done to examine pixels by moving in continuous clockwise or counter-clockwise circles 414 to determine the remaining boundaries of the polygon.

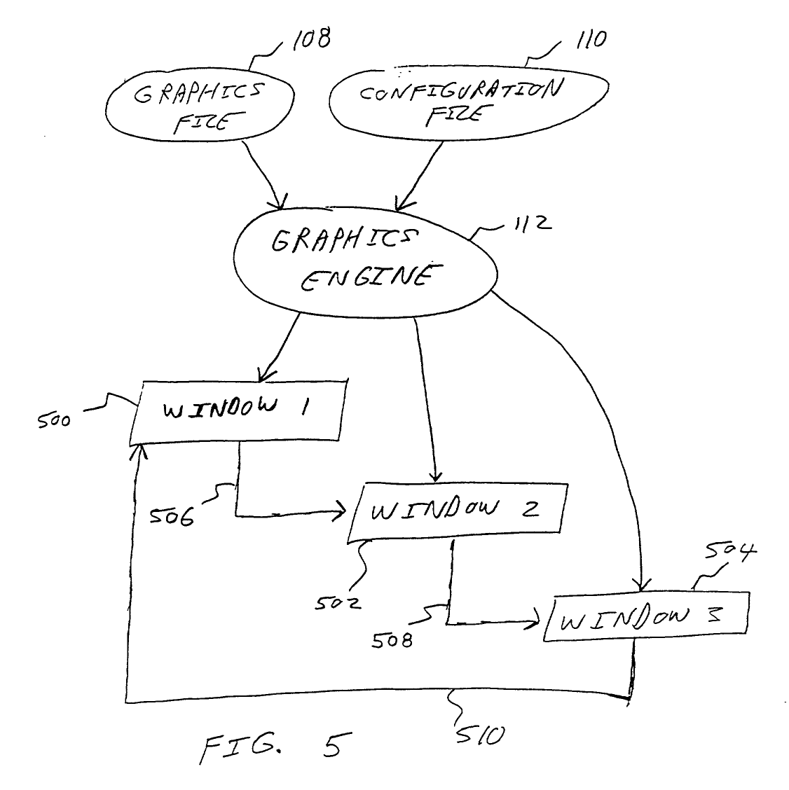

FIG. 5 illustrates the management of multiple windows 500, 502, and 504 by graphics engine 112. Window 500 is displayed by graphics engine 112 as a result of the processing of configuration file 110 and graphics file 108 as discussed above. Window 500 may correspond, for example, to image 200 or image 402 discussed above. Further, according to the present embodiment, an activation region in window 500 (as defined in configuration file 110) may point to another configuration file/graphics file pair as indicated by arrow 506. When such an activation region is, for example, clicked on with a mouse pointer by a user of computer system 100, graphics engine 112 reads the configuration file (not shown) pointed to by the activation region of window 500. This configuration file points to a corresponding graphics file (not shown) that defines window 502.

An activation region in window 502 may in turn point to another configuration file/graphics file pair (not shown) as indicated by arrow 508. Graphics engine 112 displays window 504 similarly as described above. It should be noted that graphics engine 112 may manage many such windows each of which is defined by a configuration file/graphics file pair. Also, it is possible for window 504 to point to window 500 as indicated by arrow 510.

It will be apparent to those skilled in the art that various modifications and variations can be made in the system and method for developing and processing a graphical user interface for a computer application of the present invention without departing from the spirit or scope of the invention. Thus, it is intended that the present invention cover the modifications and variations of this invention provided they come within the scope of the appended claims and their equivalents.

What is claimed is:

1. A method for displaying a first graphical image corresponding to a user interface for an application program running in a computer system, wherein the first graphical image comprises the external boundary of the visible user interface, comprising:
defining the first graphical image in a first computer file;
processing a second computer file comprising a plurality of parameters corresponding to the first graphical image; and
processing the first computer file in accordance with the plurality of parameters to display the first graphical image.

2. The method of claim 1 wherein the first computer file comprises a plurality of graphical images and each of the plurality of graphical images corresponds to one of a plurality of states of the user interface.

3. The method of claim 2 wherein the plurality of parameters define a plurality of activation regions corresponding to the first graphical image.

4. The method of claim 3 wherein the second computer file comprises a location definition and an activation region type for each of the plurality of activation regions.

5. The method of claim 4 wherein the activation region type for at least one of the plurality of activation regions points to a third computer file comprising a plurality of parameters corresponding to a second graphical image, wherein the second graphical image is defined in a fourth computer file.

6. The method of claim 2 wherein the plurality of states of the user interface comprises a default state, a selected state, and an activated state.

7. The method of claim 1 wherein the processing of the first computer file further comprises:
defining a polygon corresponding to an external boundary of the first graphical image;
storing information regarding the polygon in the computer system; and
partitioning the first graphical image into transparent and visible color regions using the information regarding the polygon.

8. A computer readable storage medium containing computer executable code for instructing a computer to operate as follows:
defining a first graphical image in a first computer file, the first graphical image corresponding to a user interface for an application program running on the computer, wherein the first graphical image comprises the external boundary of the visible user interface;
processing a second computer file comprising a plurality of parameters corresponding to the first graphical image; and
processing the first computer file in accordance with the plurality of parameters to display the first graphical image.

9. A computer system comprising a client computer and a server computer wherein the client computer and server computer are each operable to execute the method of claim 1.

10. A computer system, having a memory, for displaying a graphical image corresponding to a user interface for an application program, wherein the graphical image comprises the external boundary of the visible user interface, comprising:
a first computer file stored in the memory defining the graphical image;
and a second computer file stored in the memory defining a plurality of parameters for processing the first computer file to display the graphical image.

11. The computer system of claim 10 further comprising a graphics engine computer program running in the computer system and operable to read the second computer file for processing the first computer file.

12. A computer system for executing a process for an application program having a user interface wherein:
the process manages a plurality of corresponding graphics file and configuration file pairs; and
each of the plurality of corresponding graphics file and configuration file pairs corresponds to a window that forms at least a portion of the user interface.

13. The computer system of claim 12 wherein the plurality of corresponding graphics file and configuration file pairs defines substantially the entire user interface for the application program.

14. A method comprising developing for a third party an application program for executing a process on a computer system wherein:
the process manages a plurality of corresponding graphics file and configuration file pairs; and
each of the plurality of corresponding graphics file and configuration file pairs corresponds to a window that forms at least a portion of the user interface.

15. A computer system for executing a process for an application program for processing a configuration file that points to a corresponding graphics file for displaying a window in a user interface for the application program wherein:
the graphics file comprises a plurality of images each corresponding to a different state of the user interface; and
the plurality of images defines substantially all visible portions of the window.

16. The computer system of claim 15 wherein at least one of the group consisting of the graphics file and the configuration file is dynamically updated by a server computer coupled to the computer system.
